(19) United States
(12) Patent Application Publication
(10) Pub. No.: US 2008/0264278 A1
(43) Pub. Date: Oct. 30, 2008

(54) PRINTING METHOD BY OFFSET PRINTING PRESS AND OFFSET PRINTING PRESS

(75) Inventors: Yasuharu SUDA, Hiroshima (JP); Mitsuru TABUCHI, Hiroshima (JP); Fumiko OMAE, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 11/946,082

(22) Filed: Nov. 28, 2007

(30) Foreign Application Priority Data
Apr. 27, 2007 (JP) 2007-119655

(51) Int. Cl. B41F 5/04; B41F 1/16

(52) U.S. Cl. 101/220; 101/492

(57) ABSTRACT

A printing method by an offset printing press and an offset printing press are disclosed which suppress occurrence of curl with printing paper while making it possible to improve the printing quality by performing a ground process with aqueous ground processing material for low whiteness printing paper such as newsprint paper. To a printing face of the printing paper, aqueous ground processing material is supplied. At the same time with or later than the supply of the ground processing material, moisture is supplied to a reverse face to the printing face of the printing paper. Thereafter, offset printing is performed for the printing paper.

### BACKGROUND OF THE INVENTION

1) Field of the Invention

The present invention relates to a printing method by an offset printing press and an offset printing press suitable for use with printing by a newspaper rotary press and a newspaper rotary press.

2) Description of the Related Art

In recent years, the printing quality of a pattern of a color photograph or the like has been improved significantly. Although improvement of the printing technique and improvement of the quality of printing ink contribute to the improvement of the printing quality, also improvement of the quality of printing paper contributes very much to the improvement of the printing quality. Conversely speaking, where printing paper is limited, for example, as in printing of newspaper, the required printing pattern quality cannot be obtained sufficiently.

In particular, newsprint paper for use with a newspaper rotary press has low whiteness (or lightness) than the other printing paper. Further, for newsprint paper, light-weighted printing paper whose basis weight is low is used taking the transportability into consideration. Besides, further reduction in weight of printing paper is progressed in response to a flow of increase of pages, and therefore, also the opacity of the printing paper decreases in comparison with that of the other printing paper.

While that the whiteness and the opacity of newsprint paper are low in this manner does not make a significant obstacle to printing of an article area of the newsprint paper, this gives rise to a problem in the case of color printing of a color photograph or the like, in the case wherein a high-scanning printing region has a considerable area or in a like case. In particular, since color development of the white in color printing relies upon the color of the printing paper itself, a color tone different from a required color tone appears on at least the white portion if the whiteness of the printing paper is low. Further, if the opacity of the printing paper is low, then such a printing fault as strike-through by which a printed portion looks through the paper is likely to appear on the face of the reverse side of a high-scanning printing portion. Particularly, if the total amount of ink of printing plates (totaling four plates) in color printing exceeds 250%, then a printing fault such as strike-through is likely to occur. If strike-through appears, then the color reproducibility deteriorates.

Further, while, in the color printing of newspaper, organic pigments capable of reproducing clear colors are used for color ink of cyan (C), magenta (M) and Yellow (Y), since organic pigments have a characteristic that they have low covering power, they are likely to have an influence of the ground color.

As a result, in color printing of newspaper, the colors of CMY become dull by the influence of a grayish color of the ground of newsprint paper. Therefore, even if organic pigments having high color reproducibility are used, the color reproduction range is reduced and sufficient color reproducibility cannot be obtained.

Further, even if such strike-through as described above does not appear, it cannot be avoided with general newsprint paper that a phenomenon (dry-down) that ink (particularly, pigment) on a paper face is soaked into gaps of paper fibers in several hours after printing and decreases the printing density occurs. Also the dry-down is considered to make a cause of reduction of the color reproduction range.

Further, in the case of newsprint paper, also it is considered to make a cause of reduction of the printing density, that is, reduction of the color reproduction range, that, since the smoothness of the paper face is not sufficient, ink cannot uniformly adhere to the paper face and snowflake is likely to occur.

Further, in the case of newsprint paper, since the CMYK ink is blurred and widely coated on the surface of paper along the orientation of the fibers, the dot gain appears remarkably particularly in a halftone region whose halftone dot area ratio is approximately 30% to 60%, and a tendency appears that the halftone dot area grows fat by approximately 15% to 30%. Also the phenomenon just described causes reduction of the gradation reproducibility and makes an obstacle to improvement of the picture quality.

Therefore, in the existing circumstances, for a portion of normal newsprint paper wherein the request for whiteness cannot be satisfied or a portion wherein strike-through is likely to occur such as a color printing portion for which high picture quality is required, the requirement for picture quality is satisfied by replacing the newsprint paper at a required portion including the portion with different newsprint paper which has high whiteness.

However, since, in the case of the newsprint paper which has high whiteness, ultra lightweight coating or coating of white material is performed at a stage of papermaking in order to improve the whiteness of the newsprint paper, therefore, the printing paper becomes expensive and the cost increases. Particularly, if the printing paper is replaced in such a manner as described above, then the printing paper which is expensive and has high whiteness is used also for a reverse face for which such paper replacement is not required or for a portion of the printing paper for which such paper replacement is not required even on the same face such as a portion on which an article is to be printed.

Further, while an advertisement is sometimes printed on printing paper for advertisement having high whiteness different from newsprint paper and is inserted as an advertising circular in newspaper, since the price of the printing paper for advertisement is high and besides much time is required for insertion of the advertisement paper into newspaper, increase of the cost cannot be avoided.

Therefore, a technique is proposed in Patent Document 1 (Japanese Patent Publication No. Sho 45-25649) wherein, where characters and photographs are to be printed on the same paper face using paper whose smoothness, opacity or whiteness is low such as newsprint paper, the photographs are to be printed after a paper face improving material for increasing the smoothness, opacity and whiteness is used to partially process the portions by a printing method. Thereby the photographs are to be printed clearly while newsprint paper or the like is used.

Another technique is proposed in Patent Document 2 (Japanese Patent Laid-Open No. Hei 2-117877) wherein normal newsprint paper whose whiteness is low is processed in advance with white type ink applied to a portion of the newsprint paper on which a photograph or advertisement is to be printed, and then printing is performed such that an advertisement, a photograph or the like is printed in a required color tone while newsprint paper is used.

Incidentally, while the prior art techniques disclosed in Patent Documents 1 and 2 mentioned hereinabove use a material (ground processing material) to be coated in advance on a paper face for forming the ground of a paper face such as a paper face improving material (Patent Document 1) or ink of the white type (Patent Document 2), an aqueous material and an oil-based material are available as the ground processing material. While it is not specified in Patent Documents 1 and 2 mentioned hereinabove whether the ground processing material is of the aqueous type or the oil-based type, at least the paper face improving material disclosed on page 2, column 3 of the specification of Patent Document 1 is of the oil-based type.

On the other hand, in recent years, it is required from a point of view of environmental protection to suppress atmospheric discharge of organic solvent vapor, and the VOC (Volatile Organic Compound) emission regulation was put into force in April, 2006 and reduction of the VOC emission amount is demanded still more also in the field of printing industry. Further, naturally it is preferable to use a printing material whose content of volatile organic solvent is small also from a point of view of working environment of printing workers.

From such points of view as described above, it is preferable to use an aqueous material as the ground processing material.

It is to be noted here that the aqueous ground processing material signifies ground processing material which contains at least water. While, inmost cases, water is contained as solvent or dispersion medium (in the case of the emulsion type), water may be contained for some other object.

However, if aqueous ground processing material is supplied to printing paper, then fibers of the paper swell once and then contract by later evaporation of moisture from between the fibers. Thus, a difference in the fiber condition of the paper appears considerably frequently between the front and reverse faces of the paper, and such difference causes the printing paper to curl.

While such a situation of occurrence of curl as described above is not always same, curl occurs, for example, in such a manner as seen in FIG. 8. The example shown in FIG. 8 shows paper obtained by supplying aqueous ground processing material to newsprint paper and cutting the newsprint paper (web) and then naturally drying the cut newsprint paper. As seen in FIG. 8, the paper curls in an arc such that the face thereof to which the aqueous ground processing material is supplied comes to the inner side. As a general property, if drying advances comparatively promptly after fibers of printing paper get wet once with water and swell, then the fibers swollen once contract frequently beyond the original state. Also in this instance, it is estimated that, since drying advances comparatively promptly from the state wherein a greater amount of water is contained on the printing face side, the degree of fiber contraction on the printing face side is higher.

Where printing paper curls after printing in this manner, this gives rise to such a disadvantage that wrinkles are likely to be produced on the paper upon later handling of the printing paper or the last print curls or becomes bulky, and this is not preferable.

### SUMMARY OF THE INVENTION

It is an object of the present invention to provide a printing method by an offset printing press and an offset printing press which, while applying a technique for improving the printing quality by performing a ground process with ground processing material for low whiteness printing paper such as newsprint paper, make it possible to suppress occurrence of curl with printing paper while aqueous ground processing material is applied from a point of view of environmental protection and so forth.

In order to attain the object described above, according to an aspect of the present invention, there is provided a printing method by an offset printing press, comprising a ground processing material supplying step of supplying aqueous ground processing material at least to a printing face of printing paper, a printing step of performing offset printing on the printing face after the ground processing material supplying step, and a moisture supplying step, executed at the same time with or later than the ground processing material supplying step but prior to the printing step, of supplying moisture to a reverse face to the printing face of the printing paper.

It is to be noted that the printing face here is a printing face which makes an object of supplying of the ground processing material, and the reverse face to the printing face is a face on which printing is not to be performed or a printing face which does not make an object of supplying of the ground processing material.

With the printing method, it becomes possible to enhance the smoothness, opacity or whiteness of the printing face by the ground process, and printing can be performed excellently on the printing face. Particularly, it becomes possible to clearly print a color print with high color reproducibility. Further, since the aqueous processing material is used, contribution to the environmental protection and so forth can be anticipated.

Further, where one of the faces of the printing paper is used as the printing face and the aqueous ground processing material is used, although curl is likely to occur with the printing paper since the moisture condition is different between the printing face and the reverse face to the printing face, since the moisture is supplied also to the reverse face, the moisture conditions of the printing face and the reverse face can be made proximate to each other. Consequently, occurrence of curl with the printing paper is suppressed. Accordingly, such a disadvantage that the printing paper wrinkles upon later handling thereof or such a disadvantage that the final printed matter curls or becomes bulky can be prevented.

Preferably, the aqueous ground processing material contains at least white pigment. With the printing method, the color reproduction range of a color printing portion can be expanded with certainty, and a color print can be printed clearly with high reproducibility.

Preferably, the printing paper is low-whiteness printing paper and the offset printing press is a newspaper rotary press. Although, where the printing paper is low-whiteness printing paper and the offset printing press is a newspaper rotary press, the color reproduction range of a color printing portion is likely to reduce and the color reproducibility of color printing is likely to deteriorate, the ground process can raise the whiteness of the printing face, and consequently, a color print can be printed clearly with high color reproducibility.

Preferably, the printing method further comprises a printing face drying step of performing a drying process for the printing face between the ground processing material supplying step and the printing step. With the printing method, the ground processing material on the printing face can be dried with certainty in a short period of time. Consequently, such a situation that the ground processing material on the printing face is mixed with printing ink to be transferred to cause the printing ink to suffer from muddiness can be prevented, and excellent printing can be achieved thereby. Particularly where printing is performed at a high speed as in a newspaper rotary press, although it is supposed that the ground processing material is not dried readily by natural drying, also in such an instance, the ground processing material on the printing face can be dried with certainty.

In this instance, preferably the printing method further comprises a reverse face drying step of performing a drying process for the reverse face between the moisture supplying step and the printing step. With the printing method, since the printing face and the reverse face can be dried while the moisture conditions of the two faces are balanced with each other, occurrence of curl with the printing paper can be suppressed.

It is to be noted that the drying process for the printing face in the present invention signifies a process by which, at a stage wherein printing is started by the printing station of the printing press, at least the ground processing material on the paper face is placed into a state wherein it is not mixed any more with the printing ink transferred by the printing station to cause the printing ink to suffer from muddiness. There is no necessity for a solvent component contained in the ground processing material to permeate into the printing paper or to volatilize into the atmospheric air until it is removed fully from the ground processing material layer on the printing paper.

Further, the drying process for the reverse face is performed in order to keep the balance between the moisture state of the reverse face and the moisture state of the printing face by the drying process of the printing face.

According to another aspect of the present invention, there is provided an offset printing press for performing offset printing on printing paper, comprising a ground processing material supplying station provided on the upstream side with respect to a first-color blanket drum nip section of a printing station for supplying aqueous ground processing material to a printing face of the printing paper, and a moisture supplying station, provided on the upstream side with respect to the first-color blanket drum nip section but at the same position as that of or on the downstream side with respect to an installation site of the ground processing material supplying station, for supplying moisture to a reverse face to the printing face of the printing paper.

With the offset printing press, it becomes possible to enhance the smoothness, opacity and whiteness of the printing face by the ground process, and printing can be performed excellently on the printing face. Particularly, it becomes possible to clearly print a color print with high color reproducibility. Further, since the aqueous processing material is used, contribution to the environmental protection and so forth can be anticipated.

Further, where one of the faces of the printing paper is used as the printing face and the aqueous ground processing material is used, although curl is likely to occur with the printing paper since the moisture condition is different between the printing face and the reverse face to the printing face, since the moisture is supplied also to the reverse face to the printing face, the moisture conditions of the printing face and the reverse face to the printing face can be made proximate to each other. Consequently, occurrence of curl with the printing paper is suppressed. Accordingly, such a disadvantage that the printing paper wrinkles upon later handling thereof or such a disadvantage that the final printed matter curls or becomes bulky can be prevented.

Preferably, the aqueous ground processing material contains at least white pigment. With the offset printing press, the color reproduction range of a color printing portion can be expanded with certainty, and a color print can be printed clearly with high color reproducibility.

Preferably, the printing paper is low-whiteness printing paper and the offset printing press is configured as a newspaper rotary press for printing newspaper. Although, where the printing paper is low-whiteness printing paper and the offset printing press is a newspaper rotary press, the color reproduction range of a color printing portion is likely to reduce and the color reproducibility of color printing is likely to deteriorate, the ground process can raise the whiteness of the printing face, and consequently, a color print can be printed clearly with high color reproducibility.

Preferably, the offset printing press further comprises a printing face drying station, provided on the upstream side with respect to the first-color blanket drum nip section but on the downstream side with respect to the ground processing material supplying station, for drying the printing face. With the offset printing press, the ground processing material on the printing face can be dried with certainty in a short period of time. Consequently, such a situation that the ground processing material on the printing face is mixed with printing ink to be transferred to cause the printing ink to suffer from muddiness can be prevented, and excellent printing can be achieved thereby. Particularly where printing is performed at a high speed as in a newspaper rotary press, although it is supposed that the ground processing material is not dried readily by natural drying, also in such an instance, the ground processing material on the printing face can be dried with certainty.

In this instance, preferably the offset printing press further comprises a reverse face drying station, provided on the upstream side with respect to the first-color blanket drum nip section but on the downstream side with respect to the moisture supplying station, for drying the reverse face. With the printing method, since the printing face and the reverse face to the printing face can be dried while the moisture conditions of the two faces are balanced with each other, occurrence of curl with the printing paper can be suppressed.

According to a further aspect of the present invention, there is provided an offset printing press for performing offset printing on both faces of printing paper, comprising a first supplying station provided on the upstream side with respect to a first-color blanket drum nip section of a printing station for selectively supplying aqueous ground processing material and moisture to one of the printing faces of the printing paper, and a second supplying station provided in an opposing relationship to a ground processing material supplying station for selectively supplying aqueous ground processing material and moisture to the other of the printing faces of the printing paper.

With the offset printing press, where the ground processing material is required for one of the two printing faces of the printing paper while it is not required for the remaining printing face, to the printing face for which the ground processing material is required, the aqueous ground processing material is supplied by the first or second supplying station, but to the printing face for which the ground processing material is not required, moisture is supplied by the second or first supplying station. Consequently, the printing face to which the ground processing material is supplied can print a color print clearly with high color reproducibility. On the other hand, since the moisture is supplied to the printing face for which the ground processing material is not required, the moisture conditions of the printing face to which the ground processing material is supplied and the printing face reverse to the printing face to which the ground processing material is not supplied can be made proximate to each other. Consequently, occurrence of curl with the printing paper can be suppressed.

On the other hand, where the ground processing material is required for both of the printing faces of the printing paper, if the aqueous ground processing material is supplied to both printing faces by the first and second supplying stations, then a color print can be printed clearly with high color reproducibility on both printing faces. Further, since the moisture conditions of both printing faces approach each other, occurrence of curl with the printing paper is suppressed.

Further, if no ground processing material is required for both printing faces of the printing paper, then none of the aqueous ground processing material and moisture may be supplied.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a schematic view showing a configuration of part of an offset printing press according to a first embodiment of the present invention;

FIGS. 2(a) and 2(b) are views illustrating a concept regarding dehydration of ground processing material supplied to the printing face of printing paper and moisture supplied to the reverse face to the printing face according to embodiments of the present invention and wherein FIG. 2(a) illustrates a state before the dehydration of the ground processing material and moisture and FIG. 2(b) illustrates a state after the dehydration of the ground processing material and moisture progresses;

FIG. 3 is a front elevational view showing a printing face of newsprint paper according to the first embodiment of the present invention;

FIG. 4 is a flow chart illustrating a printing method by the offset printing press according to the first embodiment of the present invention;

FIG. 5 is a perspective view illustrating an effect according to the first embodiment of the present invention;

FIG. 6 is a schematic view showing a configuration of part of an offset printing press according to a second embodiment of the present invention;

FIG. 7 is a schematic view showing a configuration of part of an offset printing press according to a third embodiment of the present invention; and

FIG. 8 is a schematic perspective view illustrating a subject to be solved by the present invention.

### DESCRIPTION OF THE PREFERRED EMBODIMENTS

In the following, embodiments of the present invention are described with reference to the drawings.

### First Embodiment

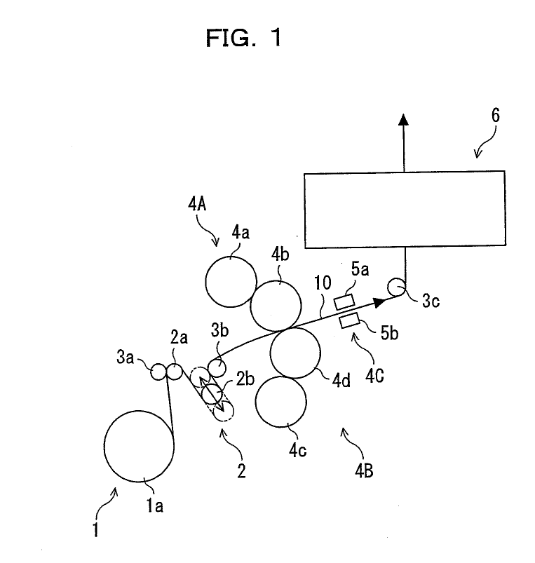

First, a first embodiment of the present invention is described with reference to FIGS. 1 to 5.

The present embodiment relates to a newspaper rotary press as an offset printing press. Referring to FIG. 1, a ground processing material supplying apparatus 4 is additionally provided on the upstream side of a printing station (printing apparatus) 6 of the newspaper rotary press. The ground processing material supplying apparatus 4 includes a ground processing material supplying station (ground processing material supplying apparatus) 4A for supplying aqueous ground processing material to a printing face of newsprint paper (hereinafter referred to sometimes as web) 10 in the form of a web as printing paper and a moisture supplying station (moisture supplying apparatus) 4B for supplying moisture to the reverse face to the printing face of the newsprint paper 10.

It is to be noted that the ground processing material is a material for improving the printing face. Here, since an example is described wherein aqueous white ink is used as the ground processing material, the ground processing material supplying station 4A is sometimes referred to as white ink supplying station (white ink supplying apparatus). It is to be noted that, while general paper having, for example, whiteness of approximately 54% to 55% and a basis weight of approximately 42 to 44 g/m² is used as the newsprint paper (web) 10, the paper to be used is not limited to this.

Further, the reason why moisture is supplied to the reverse face to the printing face of the printing paper to which the ground processing material is supplied is that, since, if aqueous ground processing material is supplied to only one of the faces of the printing paper, then the printing paper curls typically in a state wherein the face to which the ground processing material is supplied comes to the inner side by swelling of fibers of the paper and later contraction of the fibers, it is intended to avoid the curl of the printing paper. Here, the moisture may be liquid whose main component is water, and may contain chemical additive for applying or assisting some other function or the like. Here, liquid (moisture applying liquid) 30 which contains moisture 31 as a main component is supplied to the reverse face.

It is to be noted that preferably an aqueous ground processing material which contains white pigment is used as in the present embodiment in order to expand the color reproduction range of a color printing portion. The refraction index of rutile type titanium dioxide which is commonly used as white pigment is 2.71 and the difference in refraction index from resin is great. If the rutile type titanium dioxide is used for ink, then since great refraction of light occurs at an interface between titanium dioxide fine particles and binder resin, a high degree of whiteness is achieved. However, the white pigment is not limited to the titanium dioxide. For example, zinc oxide may be used as occasion demands although the refraction index thereof is 1.95 and the whiteness thereof is lower than that of titanium dioxide. A single kind of white pigment may be used or plural kinds of white pigment may be used at the same time. It is to be noted that ground processing material which contains white pigment as solid fine particles is hereinafter referred to as white ink.

As the whiteness of the surface of printing paper increases, the color development property of ink placed on the surface improves. For example, since the covering power of color ink such as CMY ink for which organic pigment is used is not high, the color ink is liable to be influenced by the color of the ground, and where the printing paper which is the ground is colored to gray, for example, like newsprint paper, the CMY colors become dull by an influence of the gray color. However, if the printing paper whose whiteness is increased by the white ink is used for printing, then it becomes possible for the CMY colors to become dull and the color reproduction range is expanded.

In order to expand the color reproduction range to achieve vivid color development in color printing, it is preferable to set the whiteness of printing paper to which white ink is supplied to 60% or more at the stage before offset printing.

More particularly, in the newspaper rotary press, the web 10 equipped in the form of roll paper 1a in a paper supplying station 1 is delivered from an in-feed station 2 and transported to the printing station 6, and ink of required colors is transferred to the web 10 by a printing unit (not shown) provided in the printing station 6 and then the resulting web 10 is outputted as a folded quire through a cooling station, a web passing station and a folding machine (all not shown).

The in-feed station 2 includes an in-feed roller 2a, a dancer roller 2b for adjusting the tension of the web 10 while moving to change the web-pass distance, a guide roller 3a disposed in an opposed relationship with the in-feed roller 2a across the web 10, and another guide roller 3b disposed on the outgoing side of the web 10 from the dancer roller 2b, and delivers the web 10 toward the printing station 7 while retaining the web 10 in a set state.

It is to be noted that, while, where single color printing is to be performed, a single printing unit is provided in the printing station 6, the printing station 6 here includes a plurality of, for example, four printing units corresponding to four color inks for cyan (C), magenta (M), yellow (Y) and black (k) in order to perform multi-color printing such as full color printing.

The ground processing material supplying apparatus 4 is additionally provided on the downstream side with respect to the dancer roller 2b which is an apparatus for changing the web-path length of the in-feed station 2 in such an existing newspaper rotary press as described above but on the upstream side with respect to a first-color blanket drum nip section (not shown) of the printing station (here, on the upstream side with respect to the location of the guiding roller 3c provided at the entrance of the printing station 6).

The ground processing material supplying apparatus 4 in the present embodiment includes the ground processing material supplying station 4A for supplying ground processing material 20 to the side of one (in FIG. 1, upper side one) of the opposite printing faces of the web 10, the moisture supplying station 4B for supplying moisture (moisture applying liquid 30) to the side of the other printing face (in FIG. 1, lower side face), and a drying processing station 4C for drying both printing faces.

The ground processing material supplying station 4A is configured similarly to a printing unit of a general offset printing press and includes a ground processing material supplying roll 4a for supplying the ground processing material to a lithographic plate and a printing drum 4b on which a lithographic plate corresponding to the supplying region of the ground processing material is mounted. Also the moisture supplying station 4B is configured similarly to a printing unit of a general offset printing press and includes a moisture supplying roll 4c for supplying moisture to the lithographic plate and a printing drum 4d on which a lithographic plate corresponding to the supplying region of moisture is mounted.

It is to be noted that the lithographic plates 4b and 4d here individually have a surface property by which ground processing material or moisture can be transferred to a region corresponding to that of the printing face to which the ground processing material or the moisture is to be coated similarly to a lithographic plate in normal plate printing. Further, the region of one of the printing faces to which the ground processing material is to be coated is defined as a region for which, for example, color printing is to be performed and the region of the other one of the printing faces to which moisture is to be coated is defined as a corresponding region just reverse to the region to which the ground processing material is to be coated.

However, more simply, it seems a possible idea to use a lithographic plate which has solid density over the entire face thereof for coating moisture on the entire face of an object printing face irrespective of a coating region of the lithographic plate to be mounted on the printing drum 4b for coating the ground processing material as the lithographic plate to be mounted on the printing drum 4d for supplying moisture. In this instance, a moisture transfer drum for directly coating moisture from the outer circumferential face thereof to an object printing face may be used in place of the printing drum 4d which has the lithographic plate mounted on the outer periphery thereof. Still more simply, it seems a possible idea to use a lithographic plate which has solid density over an entire face thereof for coating the ground processing material or moisture to the entire face of an object printing face the lithographic plate to be mounted on each of the printing drum 4b for coating the ground processing material and the printing drum 4d for supplying moisture. Also in this instance, a ground processing material drum or a moisture transfer drum for directly coating moisture from the outer circumferential face thereof to an object printing face may be used for the printing drums 4b and 4d which have the lithographic plate mounted on the outer periphery thereof.

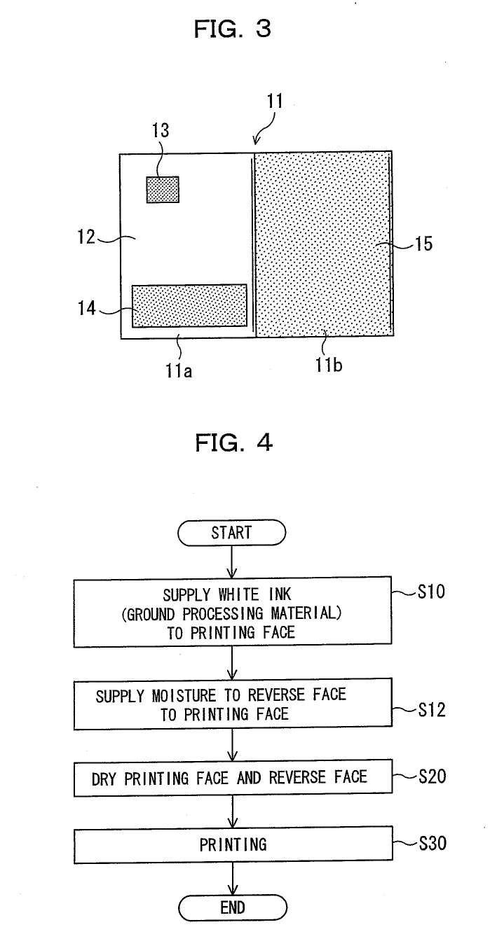

It is to be noted that, as seen from printed and cut newsprint paper 11 in FIG. 3, supplying of the ground processing material onto the web 10 by the ground processing material supplying apparatus 4 is performed only for required portions (here, a printing portion 13 for a photograph and printing portions 14 and 15 for advertisement) on the printing faces (printing pages) 11a and 11b. It is to be noted that white color ink is used as an example of the ground processing material to be supplied to the newsprint paper 11, and the white color ink is not supplied to a portion 12 of the printing face 11a on which an article is printed. In other words, by preparing lithographic plates for white color ink corresponding to the required portions 13, 14 and 15 and mounting the lithographic plates on the printing drum 4b to perform printing, such a process as described above can be performed.

Further, though not shown, for the printing face of the reverse face to the printing faces (printing pages) 11a and 11b, by preparing a moisture supplying lithographic plate for supplying moisture to the entire face and mounting the plate on the printing drum 4d to perform printing, moisture for preventing curl is supplied to required portions of the reverse face or to the entire reverse face.

It is to be noted that, while a printing portion of a lithographic plate for white ink or for basic ink or special color ink may be set as a solid (half-dot area coefficient 100%) printing portion, the printing portion may be set otherwise as a suitable half-dot form portion different from a solid printing portion. In this instance, drying of ink can be quickened while improvement of the whiteness of the printing face of the web 10 or of the optical density of ink is achieved to some degree.

Further, the ground processing material supplying apparatus 4 is provided on the downstream side with respect to the dancer roller 2b which is an apparatus for varying the web path length of the in-feed station 2 but on the upstream side with respect to the blanket drum nip section for the first color of the printing press. Therefore, the phase of the lithographic plate for white ink can be easily adjusted with those of the lithographic plates in the printing station 6, and printing of the white ink on the required portions 13, 14 and 15 can be performed with certainty as seen in FIG. 3.

Also it seems a possible idea to configure the ground processing material supplying station 4A and the moisture supplying station 4B such that, as a configuration for utilizing the existing printing press more effectively, the guide roller 3b shown in FIG. 1 or the like is used in place of the impression drum for the ground processing material supplying station 4A or the moisture supplying station 4B.

Or, as occasion demands, a printing drum may be provided at the position of each of the ground processing material supplying roll 4a and the moisture supplying roll 4c while a transfer drum for transferring the ground processing material or moisture supplied from the ground processing material supplying roll 4a or the moisture supplying roll 4c to the surface (printing face) of the web 10 is provided at the position of each of the printing drums 4b and 4d. In this instance, for example, a drum corresponding to a blanket drum for a commercial offset rotary press or a newspaper rotary press may be used as the transfer drum.

Further, particularly since moisture supplying to printing paper is performed in order to prevent curl, a comparatively simple supplying mode that moisture is supplied to the entire object face may be applied as described above. Therefore, not only a method which uses a roller but also a coater method which uses a slit coater, a spraying method, a vapor spraying method and so forth may be applied.

It is to be noted here that ground processing material is transferred to one of the printing faces of the web 10 while the ground processing material is not transferred to the other one of the printing faces of the web 10. This is because, while a printing portion for a photograph at which importance is attached to the color reproducibility is provided on one of the printing faces and it is necessary to supply the ground processing material to expand the color reproducibility range of the printing face, a printing portion for a photograph at which importance is attached to the color reproducibility is not provided on the other one of the printing faces and it is not required particularly to supply the ground processing material to the other one of the printing face to expand the color reproducibility range of the printing face.

However, in double-sided printing such as newspaper printing, various cases can be supposed which include a case wherein it is necessary to supply the ground processing material to both of the printing faces, another case wherein it is necessary to supply the ground processing material to one of the printing faces but is not necessary to supply the ground processing material to the other one of printing faces, a further case wherein it is not necessary to supply the ground processing material to one of the printing faces but it is necessary to supply the ground processing material to the other one of printing faces, and a still further case wherein it is not necessary to supply the ground processing material to any of the printing faces.

Taking such various cases as described above into consideration, in the printing press for performing double-sided printing, it is effective to provide a supplying station for selectively supplying one of ground processing material and moisture to a printing face for each of the printing faces so that ground processing material and moisture can be selectively supplied to the printing faces. For example, the ground processing material supplying station 4A shown in FIG. 1 is provided as a first supplying station for supplying one of ground processing material and moisture to a printing face while the moisture supplying station 4B shown in FIG. 1 is provided as a second supplying station for supplying one of ground processing material and moisture to the other printing face.

Then, where ground processing material is to be supplied to both printing faces, the first and second supplying stations individually supply the ground processing material to corresponding printing faces, but where the ground processing material is to be supplied to one of the printing faces, the supplying station by which the ground processing material is to be supplied from between the first and second supplying stations supplies the ground processing material to the corresponding printing face while the other supplying station supplies moisture to the corresponding printing face. On the other hand, where the ground processing material need not be supplied to any of both printing faces, the first and second supplying stations do not supply any of the ground processing material and moisture.

Naturally, where the printing press itself is only ready for one-sided printing, the ground processing material supplying station 4A may be provided on the printing face side while the moisture supplying station 4B is provided on the non-printing face side.

Also in this instance, where the ground processing material need not be supplied to the printing face, any of the ground processing material and the moisture should not be supplied.

Further, the drying processing station 4C provided on the downstream side with respect to the ground processing material supplying apparatus 4 quickly dries one of the printing faces of the web 10 to which the ground processing material 20 is transferred and dries the other one of the printing faces of the web 10 to which the moisture applying liquid 30 is transferred in a corresponding relationship with the drying of the one printing face. In the present embodiment, a heater (printing face drying section) 5a for heating and drying one of the printing faces to which the ground processing material 20 is transferred and another heater (reverse face drying section) 5b for heating and drying the other one of the printing faces (reverse face) to which the moisture applying liquid 30 is transferred are provided in an opposed relationship with each other in the drying processing station 4C.

It is to be noted that, for the heaters 5a and 5b, various types of apparatus can be applied including an apparatus of the warm air type which blows warm air on the printing face of the web 10 to perform drying, an apparatus of the vapor type which blows high-temperature vapor on the printing face of the web 10 to perform drying, an apparatus of the type which irradiates an infrared ray, an apparatus of the type which is a combination of suitable ones of the apparatus of the types described (all of them are the non-contacting types), and an apparatus of the high-temperature roll type wherein a high-temperature roll is contacted with the printing face of the web 10 and rotated at a circumferential speed in synchronism with the speed of the web 10.

Here, any apparatus of the warm air type, vapor type, infrared ray irradiating type and high-temperature roll type is used, the web 10 can be heated and dried not only from the printing face side but also from the reverse side to the printing face. Further, where the ground processing material is of the energy ray hardening type which is hardened by an electron ray, an ultraviolet ray or the like, the drying apparatus can be formed as of the type which irradiates an electron ray or an ultraviolet ray.

Particularly, it is preferable to suitably use high-temperature vapor because it prevents such a fault as contraction of the web 10 by moisture reduction by heating of the web 10. For example, an apparatus of the contact type wherein a high-temperature roller is contacted with the web, and also it is possible to provide a high-temperature roller separately or to cause the guiding roller 3C to generate heat such that the web can be dried in a contacting condition therewith. Here, an apparatus of the non-contacting type which uses warm air and high-temperature vapor in combination is used.

Now, a behavior characteristic of solvent (moisture) in the ground processing material which has an influence on a drying characteristic of aqueous ground processing material is described.

A drying step includes a permeation step (permeation process) of permeating solvent (moisture) contained in ground processing material into printing paper and an evaporation step (evaporation process) of evaporating the solvent permeated in the printing paper to atmosphere. Thus, drying is performed by the two steps.

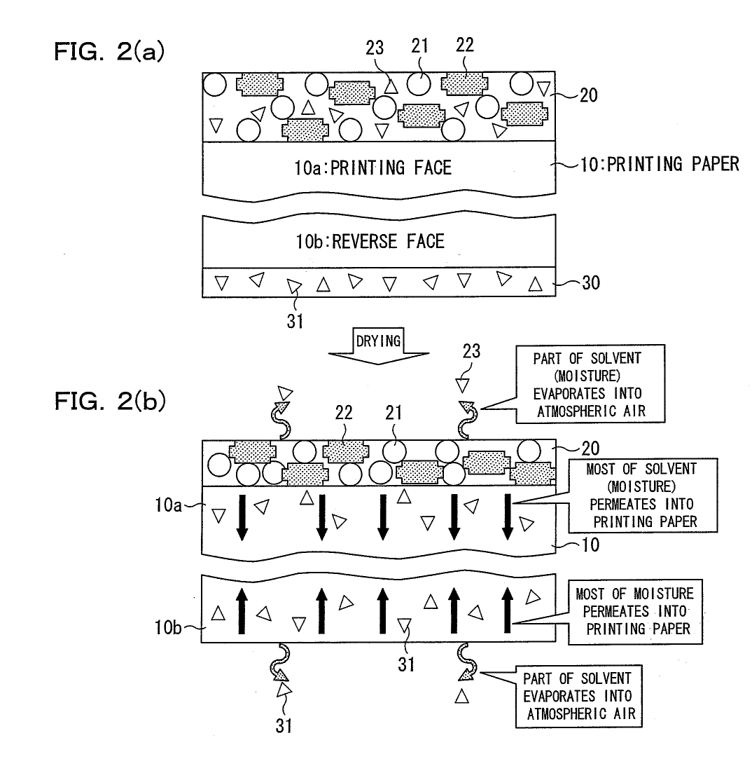

FIGS. 2(a) and 2(b) illustrate a concept of the drying step of the ground processing material. As seen in FIGS. 2(a) and 2(b), the ground processing material 20 includes at least pigment 21 as coloring material, binder resin 22, and solvent (moisture) 23. While, immediately after the ground processing material is coated on the printing paper 10, a ground processing material layer formed from the ground processing material 20 includes all of the pigment 21, binder resin 22 and solvent (moisture) 23 as seen in FIG. 2(a), the solvent (moisture) 23 is gradually removed as the drying step progresses as seen in FIG. 2(b).

At the drying step, drying of the ground processing material is achieved while permeation of the solvent into the printing paper and evaporation of the solvent to the atmosphere progress at the same time. In this instance, naturally the drying of the ground processing material is achieved more quickly as the solvent is permeated more quickly into the printing paper and is evaporated (vaporized) more quickly.

While, where water is used as the solvent, quick evaporation (volatilization) by natural drying is difficult, since permeation of the solvent into the printing paper is performed quickly, drying of the ground processing material is achieved quickly from this phase. If the printing face to which the ground processing material is supplied is dried compulsorily by the drying processing station 4C as in the present embodiment, then since not only the solvent (moisture) remaining on the surface of the printing face but also part of the solvent (moisture) permeated in the printing paper are evaporated, drying of the ground processing material is achieved quickly.

It is to be noted that the dry state in the present invention signifies that at least the ground processing material on the paper face is placed into a state wherein it is not mixed with the printing ink transferred by the printing station 6 to cause the printing ink to suffer from muddiness. Therefore, all solvent (moisture) in the ground processing material need not be transferred from the ground processing material layer on the paper face into the printing paper or into the atmosphere.

At such a drying step of the ground processing material as described above, since the solvent (moisture) permeated in the printing paper causes fibers of the paper to swell once and thereafter contract when the solvent is evaporated from between the fibers, usually a difference in the fiber state of the paper appears between the opposite faces of the paper and gives rise to curl of the printing paper. Here, however, since the ground processing material 20 is supplied to one of the printing faces while the moisture applying liquid 30 is supplied to the reverse face to the printing face (the other one of the printing faces) as seen in FIG. 2(a), the moisture 31 permeates into the printing paper on both faces of the printing paper. Therefore, swelling and later contraction of the fibers of the paper by the moisture can occur substantially uniformly on both faces of the paper.

It is to be noted that, also as regard the moisture supplying as a countermeasure against curl, if dehydration of moisture from the paper face is insufficient, then there is the possibility that oil-based printing ink to be transferred by the printing station 6 may become less likely to adhere to the paper face (a water film repels the oil-based ink). Therefore, also as regards the supplying face of moisture, it is necessary to establish at least such a degree of a drying state that oil-based printing ink does not become less likely to adhere to the paper face.

Since the newspaper rotary press as an offset printing press according to the first embodiment of the present invention is configured as described above, printing on the surface (printing face) of the web 10 is performed as illustrated in a flow chart in FIG. 4.

Referring to FIG. 4, white ink (ground processing material) is first supplied by the white ink supplying station 4A of the white ink supplying apparatus 4 to one of the printing faces of the web 10 delivered from the paper supplying station 1 while the tension state thereof is adjusted by the in-feed station 2 (step S10; ground processing material supplying step). The supplying of the white ink is performed only for the predetermined portions 13, 14 and 15 (FIG. 3) by a printing method.

At the same time, moisture is supplied to the other one of the printing faces of the web 10 by the moisture supplying station 4B (step S12; moisture supplying step).

Then, the web 10 advances to the drying processing station 4C, in which the opposite printing faces (object printing face of the ground processing material and the reverse face to the object printing face) of the web 10 are heated and dried by the heater 5 (step S20; drying step). Then, printing is performed by the printing station 6 (step S30; printing step).

As described above, the white ink on the printing face is dried, and, at the stage wherein printing is started by the printing station 6, a state is established already wherein the white ink is not mixed any more with printing ink transferred by the printing station 6 to cause the printing ink to suffer from muddiness. Therefore, the printing is performed without causing the printing ink to suffer from muddiness.

Consequently, the surface of the newsprint paper (web) 10 having low whiteness is processed to different whiteness lower than that of the white ink, and a full-color photograph (printing portion 13 in FIG. 3) or an advertisement (printing portions 14 and 15 in FIG. 3) is printed without suffering from muddiness and so forth of the printing ink. As a result, printing in a color tone to be reproduced can be implemented making use of the ground of high whiteness. Particularly, a photograph can be printed faithfully to an original picture, and an advertisement can be printed, for example, faithfully to an original picture or can be printed with a higher degree of vividness and with a high advertising effect.

Further, in the present embodiment, since the white ink is supplied only to an area of a photograph or an advertisement on the printing face, that is, only to part of the printing face, ground processing can be performed efficiently and the processing cost can be suppressed. Further, the article portion 12 can be read rather readily by applying no such ground processing thereto.

Furthermore, since aqueous white ink is used as the ground processing material, there is an advantage that contribution to environmental protection and so forth can be anticipated.

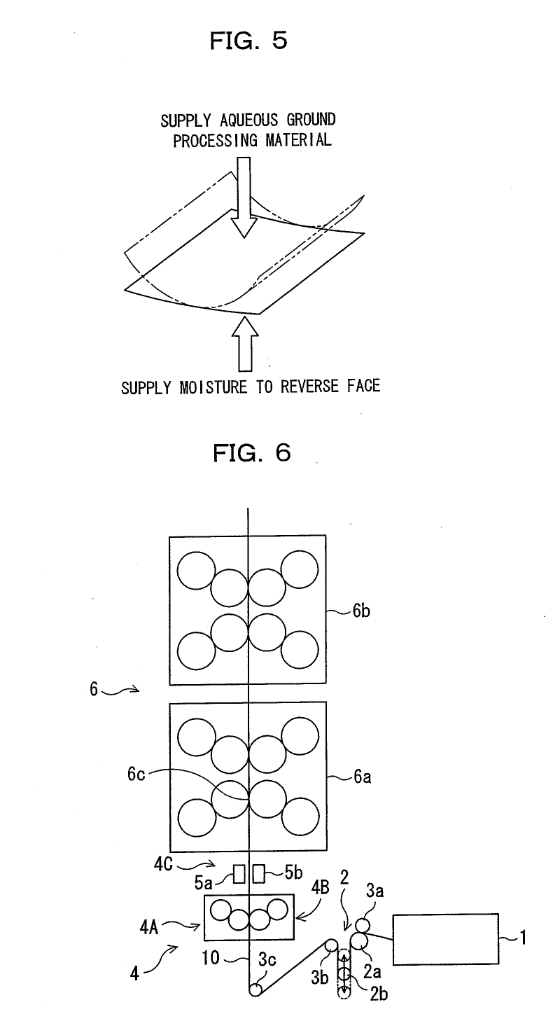

Particularly since solvent (moisture) of white ink permeated in printing paper causes fibers of the paper to swell once and then causes, when it evaporates from within the fibers, the fibers to contract, a difference in the fiber condition appears between the front and reverse faces of the paper and curl of the printing paper is caused. However, according to the present embodiment, since white ink is supplied as the ground processing material to one of the printing faces while moisture is supplied to the reverse face (the other printing face) to the printing face and hence moisture permeates into the printing paper on the opposite faces of the printing paper, swelling of the fibers of the paper and later contraction of the paper by moisture can be caused to appear uniformly substantially on the opposite faces of the printing paper. Consequently, the moisture conditions in the printing face and the reverse face can be made close to each other, and occurrence of curl of the printing paper can be suppressed as seen in FIG. 5. Accordingly, such a disadvantage that printing paper wrinkles upon later handling thereof or such a disadvantage that the final printed matter curls or becomes bulky can be prevented.

For example, Table 1 indicates the curvature of the curl (=reciprocal to the radius of curvature) as a result when the printing method by an offset printing press according to the present embodiment is applied such that white ink is printed on the entire face of one of paper faces of a web having a basis weight of 43 g/m² and a whiteness of 55% and having a paper width of 15 cm corresponding to that of newsprint paper while moisture for preventing curl is supplied to the entire reverse face simultaneously with the supply of the white ink.

It is to be noted that printing by process color ink is omitted. Further, the white ink was produced by diluting the Brightone FC-765 white by Sakata Inx with water so that the viscosity measured using the Zahn cup R#4 by RIGO may become 8 seconds. The white ink after diluted was supplied so that the whiteness of the newsprint paper after printing may be 64%, and the moisture for curl prevention was adjusted so that the water film supplied to the newsprint paper may have a thickness of 0.5 μm. Then, after the printing ended, the newsprint paper (Web) was cut out, and the curvature of the curl thereof was measured using a curl measuring instrument by Kitahama. It is to be noted that, as a comparative example, also the curvature of newsprint paper on which nothing was printed was measured and additionally indicated in Table 1.

TABLE 1
Curl measurement results of newsprint paper after
printed

Curl curvature (1/m)

| Measurement | | Moisture | No moisture |
|---|---|---|---|
| sample | Whiteness | supplied | supplied |
| Non-printed | 55 | 3.63 | — |
| newsprint paper | | 5.51 | — |
| | | 2.45 | — |
| Newsprint paper to | 64 | 40.96 | 18.42 |
| which white ink is | | 39.21 | 14.98 |
| supplied | | 36.31 | 16.97 |

As seen from Table 1, since the printing paper used in the present experiment was a web equivalent to newsprint paper, some curl is found with the printing paper also in a non-printed condition. However, it is recognized that, while the curvature of the newsprint paper to which only white ink was supplied exhibits a noticeable increase, the curl curvature apparently decreases if moisture is supplied for prevention of the curl. When it is desired to further decrease the curvature after printing, such adjustment as to increase the moisture supply amount or a like countermeasure may be adopted.

### Second Embodiment

Now, a second embodiment of the present invention is described. FIG. 6 shows a general configuration of an offset printing press according to the second embodiment of the present invention. In FIG. 6, like reference characters to those of FIG. 1 denote like elements, and overlapping description of them is omitted herein to avoid redundancy.

While, in the first embodiment, the ground processing material supplying apparatus (ground processing material supplying section 4A, moisture supplying section 4B and drying processing section 4C) 4 is provided additionally in an existing newspaper rotary press, in the present embodiment, the ground processing material supplying apparatus 4 is incorporated in the newspaper rotary press from the beginning. In particular, as seen in FIG. 6, the ground processing material supplying apparatus 4 is provided on the upstream side with respect to and in a juxtaposed relationship with a printing apparatus 6 which includes printing units 6a and 6b and so forth. Except this, the second embodiment is configured similarly to the first embodiment. It is to be noted that, also in the present embodiment, aqueous white ink is used as the ground processing material.

Also in the present embodiment, the ground processing material supplying section 4A is provided on the downstream side with respect to the dancer roller 2b which is an apparatus for varying the web path length in the in-feed station 2 (here, on the downstream side with respect to the guide roller 3c which guides the newsprint paper (web) 10 to the printing apparatus 6) but on the upstream side with respect to a blanket drum nip 6c of the printing unit 6a for the first color of the printing apparatus 6 similarly as in the first embodiment. Therefore, the phase of a lithographic plate for white ink can be easily adjusted with those of lithographic plates in the printing station 6, and printing of the white ink on the required portions 13, 14 and 15 described hereinabove in connection with the first embodiment of the present invention can be performed with certainty.

Meanwhile, the moisture supplying section 4B is disposed in an opposing relationship with the ground processing material supplying section 4A, and the drying processing section 4C is disposed on the downstream side with respect to the ground processing material supplying section 4A and the moisture supplying section 4B.

Also with such a configuration as described above, the present second embodiment of the present invention contributes to environmental protection and so forth through use of aqueous white ink as the ground processing material similarly as with the first embodiment. Besides, occurrence of curl with printing paper which is likely to occur where aqueous ground processing material is used can be suppressed.

Naturally, also an advantage is achieved that printing with printing ink is performed without suffering from muddiness and so forth of the printing ink by the white ink and printing of a color tone to be reproduced can be implemented using the ground of high whiteness.

### Third Embodiment

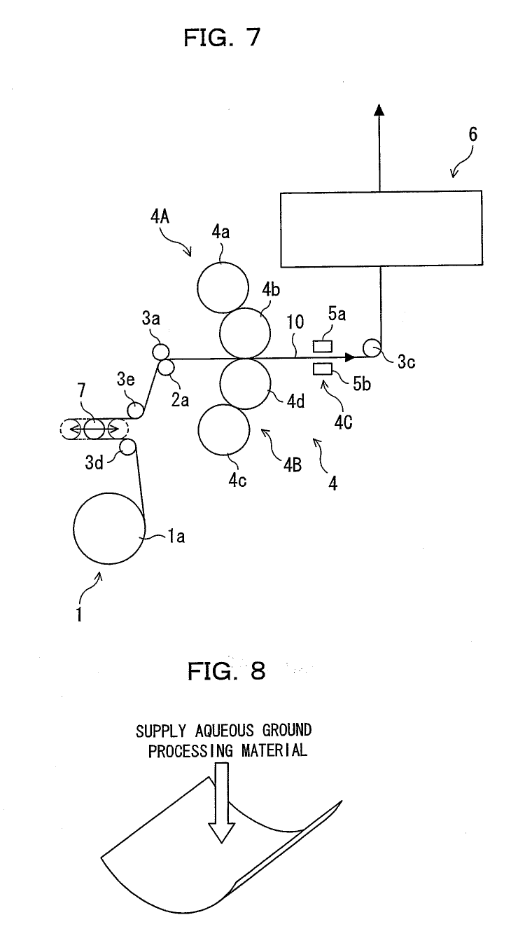

Now, a third embodiment of the present invention is described. FIG. 7 shows a general configuration of an offset printing press according to the third embodiment of the present invention. In FIG. 7, like reference characters to those of FIG. 1 denote like elements, and overlapping description of them is omitted herein to avoid redundancy. Also in the present embodiment, white ink is used as the ground processing material.

In the present embodiment, although the ground processing material supplying apparatus 4 itself is similar to that in the first and second embodiments, the configuration of the printing press on the upstream side with respect to the ground processing material supplying apparatus 4 is different from that in the first and second embodiments.

In particular, while, in the first and second embodiments, a dancer roller is provided as an apparatus for varying the web path length, in the present embodiment, not a dancer roller but a floating roller 7 is provided as an apparatus for varying the web path length.

The floating roller 7 is an apparatus for absorbing the variation of the paper supply tension and moves, if the paper supply tension fails upon acceleration, upon pastering or upon emergency stopping of the rotary press, toward the left side in FIG. 7 (refer to two-dot chain line) to absorb the drop of the tension. On the contrary, if the paper supply tension rises, then the floating roller 7 moves toward the right side in FIG. 7 (refer to another two-dot chain line) to absorb the rise of the tension.

It is to be noted that the dancer roller 2b and the in-feed roller 2a described hereinabove in connection with the first and second embodiments (refer to FIGS. 1 and 6) are apparatus which positively detect the tension at the entrance of the printing unit and vary the position of the dancer roller 2b and the circumferential speed of the in-feed roller 2a to suppress the variation of the tension thereby to stabilize the tension at the entrance of the printing unit. To this end, the dancer roller 2b and the in-feed roller 2a are provided with a driving apparatus for driving the dancer roller 2b. However, the floating roller 7 does not particularly include a driving apparatus (but is a mere pendulum roller) but is an apparatus for merely absorbing the tension variation. However, the floating roller 7 is common to the dancer roller 2b and the in-feed roller 2a in that it varies the web path length.

Accordingly, where a ground process such as supplying of white ink is performed for a required portion of the web 10, the ground processing material supplying apparatus (ground processing material supplying apparatus) 4 is disposed on the downstream side with respect to the floating roller 7 which is an apparatus for varying the web path length in order to prevent displacement of the phase of the printing position which is caused by the variation of the web path length from that of the printing paper for which the ground processing is performed.

Also with such a configuration as described above, the third embodiment of the present invention contributes to environmental protection and so forth through use of aqueous white ink as the ground processing material similarly as with the first and second embodiments. Besides, occurrence of curl with printing paper which is likely to occur where aqueous ground processing material is used can be suppressed. Also an additional advantage is achieved that printing with printing ink is performed without suffering from muddiness or the like which is caused by the white ink and printing of a color tone to be reproduced can be implemented utilizing the ground of high whiteness.

It is to be noted that, where a plurality of “apparatus for varying the web path length” are involved, preferably the ground processing material supplying apparatus (ground processing material supplying apparatus) 4 is disposed on the downstream side with respect to that one of the “apparatus for varying the web path length” which is positioned on the most downstream side within a range from the paper supplying station to the nip section of the blanket drum for the first color.

### Others

While preferred embodiments of the present invention are described above, the present invention is not limited to the configurations described, and variations and modifications can be made suitably without departing from the scope of the present invention.

For example, while, in the embodiments described above, the present invention is applied to a newspaper rotary press, the present invention can be applied not only to such newspaper rotary presses but also widely to offset printing presses.

Further, while white ink is used as ground processing material, also in order to improve the whiteness, whiteness enhancing material other than white ink such as, for example, a decolorizing material may be used. Where a decolorizing material is used, since the washing step cannot be carried out readily on the printing press, it is demanded for the decolorizing material to be such a material that it itself sublimes (or evaporates) together with a coloring component of the newsprint paper.

Further, the printing paper of an object for which a ground process is to be performed is not limited to such printing paper of low whiteness as newsprint paper. Naturally, also the ground processing material is not limited to a whiteness enhancing material, but also a material which improves the smoothness of the paper surface beginning with, for example, transparent ink (for example, varnish), another material which improves the lightness (different from the whiteness) such as, for example, ink which contains a metal component or a reflectance improver or a like material can be applied.

Also it is a possible idea to use, as the ground processing material, special color ink other than white ink, that is, special color ink of any of basic ink colors of cyan, magenta and yellow or any other ink color than white and black. Since application of such special color ink to the ground significantly increases the representation variations in color and makes it possible to develop a color which provides a very high impression, it contributes to improvement of the advertising effect where it is adopted particularly to the advertisement.

A plurality of ground processing materials may be used. In particular, a plurality of ground processing material supplying apparatus similar to the ground processing material supplying apparatus 4 are provided such that they individually perform ground processes different from each other. With the configuration just described, different ground processes such as, for example, improvement of the whiteness, improvement of the brilliance of the other colors and surface smoothing can be carried out on the same paper face. Consequently, various requests for printing can be satisfied.

Further, while, in the embodiments described hereinabove, white ink (ground processing material) is supplied to an entire area of a photograph portion or an advertisement portion on a printing face, white ink (ground processing material) may otherwise be supplied only partly to a necessary portion in a photograph portion or an advertisement portion. In other words, no ground process is applied to any region within which the ground is little exposed. Consequently, the ground process can be performed with a high efficiency and the processing cost can be further reduced. It is to be noted that, also in this instance, preferably the contour for the ground process is taken rather great so that any portion for which the ground process has not been performed may not be exposed.

Further, while, in the embodiments described hereinabove, the heaters 5a and 5b are provided in the drying processing section 4C, if the ground processing material such as white ink is of the quick-drying type and dries in a short period of time at a room temperature as described hereinabove, then as a particular example of the drying processing section 4C, it is possible to configure the drying processing section 4C as a mere space which includes no heater, that is, as a natural drying (room-temperature drying) section.

Further, if a high-temperature vapor supplying section (high-temperature vapor supplying apparatus) for supplying moisture in the form of high-temperature vapor from the reverse face to the printing face is provided as a moisture supplying apparatus, then this provides an advantage that moisture is supplied to the reverse face to the printing face of printing paper by supply of high-temperature vapor thereby to prevent curl of the printing paper and drying of the aqueous ground processing material is promoted by heat of high-temperature vapor. Also it is possible to eliminate the drying processing section 4C, and the efficiency is very high.

Further, while, in the embodiments described hereinabove, the moisture supplying section 4B is disposed at the same position as the ground processing material supplying section 4A in the feeding direction of printing paper and in an opposing relationship to the ground processing material supplying section 4A, it is otherwise possible to dispose the moisture supplying section 4B on the downstream side with respect to the ground processing material supplying section 4A in the web feeding direction (naturally on the upstream side with respect to the nip section of the blanket drum for the first color in the printing station).

As an example of such an arrangement configuration as described above, it is a possible configuration to dispose a pair of ground processing material supplying sections on the opposite faces of printing paper in an opposing relationship to each other at the same position in the feeding direction of the printing paper and further dispose a pair of moisture supplying sections on the opposite faces of the printing paper in an opposing relationship to each other at the same position in the feeding direction of the printing paper on the downstream side with respect to the ground processing material supplying stations. According to the described configuration, where supplying of the ground processing material to both or none of the opposite faces of the printing paper is to be performed, moisture supplying by the moisture supplying station on the downstream side is not performed. However, where supplying of the ground processing material to only one of the faces of the printing paper by one of the ground processing material supplying stations is to be performed, the corresponding moisture supplying station should be rendered operative so that moisture supplying only to the other face of the printing paper may be performed.

Particularly, curl of the printing paper occurs because moisture as solvent for the aqueous ground processing material supplied only to one of the faces of the printing paper swells fibers of the paper once and thereafter contracts the fibers, and the reason why moisture is supplied to the reverse face to the supplying face of the aqueous ground processing material in the present invention is that it utilizes the action that the moisture supplied to the reverse face swells the fibers of the paper once and then contracts the fibers similarly to the supplying face of the aqueous ground processing material.

It is considered that particularly the contraction of the paper fibers on the reverse face is effective to prevention of curl. Further, it is considered that the contraction action occurs more strongly as the moisture is evaporated more quickly. As regards evaporation of moisture, if the printing face to which the aqueous ground processing material is supplied and the reverse face to the printing face to which the moisture is supplied are compared with each other, since the moisture permeated in the paper face of the printing face to which the aqueous ground processing material is supplied is disturbed by the pigment 21 or the binder resin 22 in the ground processing material existing on the surface of the printing face, it is considered that the moisture is less likely to evaporate than from the reverse face to which only the moisture is supplied or principally the moisture is supplied.

Accordingly, in such a condition that drying progresses in the same condition between the aqueous ground processing material supplying face and the moisture supplying face as in a case wherein natural drying is used or the opposite faces are heated to a substantially same degree, evaporation of moisture from the moisture supplying face is likely to progress quickly. In this regard, if the moisture supply is carried out on the downstream side with respect to the aqueous ground processing material supply, then the aqueous ground processing material supplying face and the moisture supplying face exhibit moisture states proximate to each other. Therefore, there is an advantage that it is easy to adjust contraction of the paper fibers to similar degrees on the two faces.

Also it is considered possible to prevent curl through supply of an amount of moisture as small as possible. In particular, if the moisture supplied to the reverse face is dried quickly by heating or the like, then the contraction action of paper fibers occurs strongly. Consequently, curl can be suppressed while a small amount of moisture is supplied to the reverse face. Also where such quick drying is performed, at a stage at which printing paper advances into the printing station, preferably the moisture state is substantially uniform over the printing paper. Taking this into consideration, it is considered effective to carry out the moisture supply on the downstream side with respect to the aqueous ground processing material supply.

Anyway, since both of moisture supply and a later drying process (process for evaporating moisture) contribute to prevention of curl, preferably they are taken into consideration to select the moisture supplying position, the moisture supplying amount and the method for the drying process.

1. A printing method by an offset printing press, comprising the steps of:
supplying aqueous ground processing material at least to a printing face of printing paper;
offset printing on the printing face after the ground processing material supplying step; and
supplying moisture, executed at the same time with or later than the supplying step but prior to the printing step, of supplying moisture to a reverse face of the printing face of the printing paper.

2. The printing method by an offset printing press as claimed in claim 1, wherein the aqueous ground processing material includes at least white pigment.

3. The printing method by an offset printing press as claimed in claim 1, wherein the printing paper is low-whiteness printing paper and the offset printing press is a newspaper rotary press.

4. The printing method by an offset printing press as claimed in claim 2, wherein the printing paper is low-whiteness printing paper and the offset printing press is a newspaper rotary press.

5. The printing method by an offset printing press as claimed in claim 1, further comprising a drying process for the printing face between the supplying step and the printing step.

6. The printing method by an offset printing press as claimed in claim 4, further comprising performing a drying process for the printing face between the ground processing material supplying step and the printing step.

7. The printing method by an offset printing press as claimed in claim 5, further comprising performing a drying process for the reverse face between the supplying moisture step and the printing step.

8. The printing method by an offset printing press as claimed in claim 6, further comprising performing a drying process for the reverse face between the supplying moisture step and the printing step.

9. An offset printing press for performing offset printing on printing paper, comprising:
a ground processing material supplying station provided on an upstream side with respect to a first-color blanket drum nip section of a printing station for supplying aqueous ground processing material to a printing face of the printing paper; and
a moisture supplying station, provided on the upstream side with respect to said first-color blanket drum nip section and at the same position as that of or on the downstream side with respect to an installation site of said ground processing material supplying station, for supplying moisture to a reverse face to the printing face of the printing paper.

10. The offset printing press as claimed in claim 9, wherein the aqueous ground processing material includes at least white pigment.

11. The offset printing press as claimed in claim 9, wherein the printing paper is low-whiteness printing paper and said offset printing press is configured as a newspaper rotary press for printing newspaper.

12. The offset printing press as claimed in claim 10, wherein the printing paper is low-whiteness printing paper and said offset printing press is configured as a newspaper rotary press for printing newspaper.

13. The offset printing press as claimed in claim 9, further comprising a printing face drying station, provided on the upstream side with respect to said first-color blanket drum nip section and on the downstream side with respect to said ground processing material supplying station, for drying the printing face.

14. The offset printing press as claimed in claim 12, further comprising a printing face drying station, provided on the upstream side with respect to said first-color blanket drum nip section and on the downstream side with respect to said ground processing material supplying station, for drying the printing face.

15. The offset printing press as claimed in claim 13, further comprising a reverse face drying station, provided on the upstream side with respect to said first-color blanket drum nip section and on the downstream side with respect to said moisture supplying station, for drying the reverse face.

16. The offset printing press as claimed in claim 14, further comprising a reverse face drying station, provided on the upstream side with respect to said first-color blanket drum nip section and on the downstream side with respect to said moisture supplying station, for drying the reverse face.

17. An offset printing press for performing offset printing on both faces of printing paper, comprising:
a first supplying station provided on the upstream side with respect to a first-color blanket drum nip section of a printing station for selectively supplying aqueous ground processing material and moisture to one of the printing faces of the printing paper; and
a second supplying station provided in an opposing relationship to a ground processing material supplying station for selectively supplying aqueous ground processing material and moisture to the other of the printing faces of the printing paper.
